(19) United States
(12) Patent Application Publication
(10) Pub. No.: US 2005/0280842 A1
(43) Pub. Date: Dec. 22, 2005

(54) Wide gamut film system for motion image capture

(75) Inventors: Nestor M. Rodriguez, Rochester, NY (US); David Long, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/065,384

(22) Filed: Feb. 24, 2005

Related U.S. Application Data
(60) Provisional application No. 60/580,238, filed on Jun. 16, 2004.

(51) Int. Cl. G06K 1/00

(52) U.S. Cl. 358/1.5

(57) ABSTRACT

A film-based image capture and processing system for producing preferred film-based image looks that include a scan-only film having reproduction contrast that increases scanning signal-to-noise ratio subject to digitization bit-depth limitations to obtain additional scene exposure differentiation. In addition, a chemical processing subsystem for developing latent images, as a result of image capture, on the scan-only film is includes as are a scanner for providing a wide gamut digital image record; and an image processor for modifying film image attributes to digitized images from the scanner.

### FIELD OF THE INVENTION

The invention relates generally to the field of photography, and in particular to motion picture film systems. More specifically, the invention relates to a film system that incorporates minimal color correction chemistry in its emulsion such that a cinematographer is able to apply any type of “film look” in post production; hence, resulting in a single film that is useful for multiple purposes and/or looks. The invention further relates to the digitization and manipulation of images captured by the film system to produce desired creative looks for final display and distribution.

### BACKGROUND OF THE INVENTION

Traditionally, high quality motion picture images are captured by a photographic film. The primary benefits of film over other image capture technologies for motion picture applications include wide exposure dynamic range, preferred color reproduction control, minimal image noise (grain), fast photographic speed, high resolution and sharpness, and flexibility in framing through various post-production operations. In general, motion picture images are used for exhibition in either theatrical projection or broadcast television distribution.

Color images on traditional film are produced by exposing light-sensitive layers coated on a flexible semi-transparent support through a film camera and lens, and subjecting the film to prescribed chemical amplification processes to produce dyes with a predictable optical density profile. In conventional motion picture applications, the original captured film image can be further printed optically onto another piece of intermediate or print motion picture film as suitable for theatrical projection. Alternatively, the optical density signature recorded on the film can be transferred to a film scanner as digital data. Once scanned, image manipulation can be imparted by way of a color corrector for either television distribution or by way of various digital techniques that prepare the image for digital intermediate theatrical distribution.

Traditional color negative films create complementary cyan, magenta, and yellow dye amounts from red green, and blue exposure, respectively. Dye amount is directly proportional to incident light intensity. The negative image must be inverted by optically printing onto another negative-acting motion picture film or by processing downstream of a scanner in order to render it suitable for positive display. Traditional color positive films create complementary cyan, magenta, and yellow dye amounts from red, green, and blue exposure also, but the dye amount is inversely proportional to incident intensity. The resulting positive image may be directly projected in theatrical distribution or be scanned without a required polarity switch.

Calibrated electro-optical scanners are used to convert film density to digital data suitable for electronic display (on a monitor or as digital cinema, for example), or to digital data suitable for driving a film recorder to produce a reproduction of the original image on another piece of film. In the case of the film recorder example, the new film image produced can be used to generate distribution prints for exhibition in conventional motion picture cinema theaters. For broadcast television exhibition, electro-optical scanners known as telecines are used to convert film density to voltage signals suitable for driving a conventional display monitor.

Images captured on a traditional color motion picture film that is designed for optical printing can exhibit a loss of detail in highlights of high dynamic range scenes after an electro-optical scan. Additionally, many electro-optical scanners use light sources that are deficient in blue light output. Conventional films, which have relatively high minimum blue optical densities resulting from the presence of color compensating chemistries and other formulation elements to produce a desired optical print, can exhibit excessive blue channel noise in an electro-optical scanner. These effects reduce image quality, therefore, making the process of digitizing film images difficult and time-consuming. Similarly, loss of highlight detail in images in electro-optical scans is commonly a result of white ‘clipping,’ wherein the electro-optical image path in the scanner system is incapable of recording the full range of optical densities reproduced on the piece of film, which again makes the image digitization process difficult and time-consuming.

When images captured with conventional motion picture origination film are chemically developed, and then optically transferred to print film or electro-optically scanned for electronic processing/display, they produce an image appearance that is primarily inherent of the “origination” film's tone, color, sharpness and texture (i.e. graininess). These “origination film attributes” all contribute to what cinematographers describe as the “film look.” A plurality of origination films are manufactured for the purpose of producing several “film looks” to satisfy the various creative needs of cinematographers. The unique look of each of these films is primarily determined by the type of light sensitive (spectral) and image processing chemistry incorporated into the film's color recording emulsions. If an alternative “image processing” means (method) were available to reproduce the many origination film looks without having the need for incorporating separate chemistry formulations in each film type, it would be advantageous (e.g. with respect to cost/workflow efficiency) to theatrical and television film productions. For instance, they would no longer have a need to carry/track inventory for multiple origination film types to satisfy the production needs (i.e., desired film looks) of the cinematographer.

Several valid examples of related prior art have been investigated to determine relevancy to the invention. Digital image processing may take place on video images, as described in U.S. Pat. Nos. 5,335,013; 5,475,425 and 5,831,673, in order to emulate the broadcast look of film or the look of film after it has been through a telecine transfer. These patents describe systems for rendering the output of a video camera to simulate the visual appearance of motion picture film that has been transferred or converted to a video signal to be output directly for television broadcasting or recording on video tape. Further, the above-cited prior art teaches three components for the emulation of the look of broadcast motion picture film. One component deals with the conversion of the video or digital material into various video formats from either 30 frames per second (fps) or 24 fps origination rate. The second component allows for the selective addition of filtered noise to the electronically captured images to give the appearance of motion picture film grain. The third component allows for the alteration of the apparent contrast of the video image so the desired broadcast film appearance may be obtained. More specifically, in the '013 patent a gray scale modifier is used as a look-up table (LUT) and the operator can choose between a variety of curves (% light level vs. video level) stored in programmable read-only memory (PROM) to reflect different film types or achieve different photographic effects. The desired curve is selected by pressing a switch on the hardware. None of these patents refers to a system for manipulating images to match the color/tone characteristics of traditional motion picture films where the starting image is derived from an electro-optical scan of a scan-only film. Further, none reference the electronic processing of scanned images where the primary image space is data and not video.

U.S. Pat. Nos. 5,140,414; 5,374,954; and 5,406,326 (each issued to Mowry) represent a family of related post-production video technology that seeks to arrive at an aesthetically acceptable simulation of the appearance that images originated on different motion picture film stocks would embody after telecine “flying spot scanner” transfer to video from taped high definition video originated images. U.S. Pat. Nos. 5,457,491 and 5,687,011 further extend the concept to providing emulations of images captured on one medium from the capture of the image on a second medium, presumably to include any film capture medium. One component of this prior art technology deals with the conversion of the video-originated material through a LUT that is based on color temperature of the scene lighting, scene brightness and selected f-stop setting. The conversion values in the LUT are derived by filming color charts and gray-scale charts, obtaining a digital representation of the film component responses of the charts from telecine transfer of the film to videotape, and then charting the telecine-derived component responses against video originated images of the same charts under identical lighting conditions. Another component of this prior art technology allows for physically instilling selected film grain patterns to the video images. The final simulated video image is either recorded as a high definition signal, or converted to an NTSC signal and broadcast or displayed.

In the latter two of the aforementioned Mowry patents, the digitized video signal may be sent to a film recorder, which reproduces the component-modified images onto a selected, reversal film stock. The film is chemically processed with a film processor and then optically projected, or scanned to video, digital video, or other electronic media. However, if the film recording option is employed, these patents specify that it is important that the telecine-derived LUT used in the component modification involves response data which compensates for the inherent color response of the film stock on which the images are being digitally recorded.

In all of the Mowry patents, the creation of image processing LUTs capable of transforming image data representative of the characteristics of one medium to characteristics representative of a second medium, those characteristics including color and tone among others, requires that reference images be necessarily captured on both media to provide statistical basis for the relationship algorithm.

U.S. Pat. No. 6,771,323 among many others, including references from Giorgianni (Digital Color Management, 1997) and others cited in U.S. Pat. No. 5,840,470, teaches how fundamental image characteristic data can be used to provide device-independent or device-dependent intermediate data appropriate for simulating the image characteristics of multiple capture or display media and devices, including film, computer monitors, or video signals from a given image capture device or media. It focuses on capturing imaging device properties such as white level, black level, color level, linearity, and frequency response, and adding those image characteristics to primary scene content to yield enhanced content. It does not, however, reference the full gamut of motion picture color film imaging characteristics that provide completely independent intermediate data, specifically those relevant to the properties of color reproduction. Further, it does not acknowledge how some intermediate image spaces, such as scene exposure or scene luminance, must still be qualified by the spectral response properties of imaging devices and converted appropriately to provide full emulation of alternate imaging devices. Finally, this art does not describe the optimized properties of an image capture film intended to be used for the creation of multiple traditional film ‘looks’ by way of image processing algorithms derived from first principles characterization of film systems.

U.S. Pat. Nos. 5,500,316; 5,576,128; and 5,705,327 all present motion picture color film designs which are optimized in one fashion or another for electro-optical scanning. Patent '316 focuses on adjusting characteristic curve properties in the red image-recording channel to compensate for spectral misalignment between film dyes and native telecine sensor response. Though useful, this feature is more relevant to producing color-balanced scanned data than to creating a film media fully optimized for scan noise performance. Further, scanner responses have been adjusted in more modern equipment to help, in part, alleviate this system spectral misalignment. Patent '128 offers advantage for telecine scans from a color motion picture film with a lower mid-scale contrast, but does not further expand the benefits of creating a defined wide dynamic range characteristic response in the upper portion of the sensitometric curve. Further, the invention described has not been designed with removal of color-compensating chemistries so as to optimize the light-capturing properties of the media, instead relying on the inclusion of more traditional image processing chemistries to yield a mostly suitable traditional look for tone and color upon electro-optical scanning. Finally, a reduction of the blue minimum density is described as a consequence of imaging chemistry and formulation changes made to yield lower mid-scale contrast in the film. What is not discussed is the lowering of this density by removal of color-compensating ‘masking’ coupler chemistries which are classically used in film designs for color compensation for optimizing optical printing. With the intent to create favorable color and tone reproduction choices via electronic image processing following electro-optical scans in the present invention, the electronic noise benefits discussed in the reference can be realized by removal of at least part of the typical amount of masking coupler employed in traditional films. Patent '327 describes a characteristic response ratio of mid-scale contrast to lower-scale contrast which helps to improve shadow rendition in images electro-optically scanned from motion picture color film origination. While beneficial to the concept of a wide dynamic range film optimized for electro-optical scanning applications, the reference invention makes no claim to benefits realized from full scale response shaping, particularly in the upper-scale response. Further, the reference invention infers a traditional color film with color-compensating chemistries for producing a traditional preferred tone and color rendition upon scanning rather than a film optimized for light capture with image look features to be added electronically by mathematical image processing. In all three of these references, the benefits of a single film, capable of being electronically processed to add in desired traditional tone, color, grain, and texture elements are not described. Further, detail of the full optimization of the characteristic contrast across a wide dynamic range and against both an upper and lower bound are not offered as they are in the present invention. Finally, in only patent '316 is consideration given to defining the characteristic response of a film in device-dependent scanning density as opposed to more generic ANSI status M density which may mask the important spectral properties of both film dyes and device spectral sensitivities.

U.S. Pat. Nos. 5,840,470 and 6,686,136 each define the concept of photographic films designed with the removal of color-compensating chemistries to reduce electro-optical scan noise, with preferred embodiments of image color and tone to be added back in electronically via subsequent image processing. The premise of patent '470 is to create a new film product capable of alternative rapid photochemical processing following exposure, allowing for an increased efficiency of digital image generation from film origination. Tangible electronic noise benefits of specific film characteristics for electro-optical scanning are not taught, and are, in fact, more generically bounded than is thought reasonable in the present invention. Further, the removal of color-compensating chemistries as referenced in the invention is a premise by which to enable rapid processing formulation design and is not reflective of attempts to optimize light capture performance for both overall noise (film grain and electronic) and capture dynamic range in a traditional photochemical amplification process, though such benefits are described as ancillary to the rapid-processing film characteristic response. Patent '136 provides evidence of film design optimized for electronic image noise, but the application is intended for single-use camera still capture systems. Further, the reference does not teach how the film characteristic response can be designed with a bounded contrast to fully co-optimize electro-optical scanning for motion picture applications. Finally, it does not go into any detail on defining the linearity characteristic of the film response curve as is done in the present invention.

Thus, there is still a need for a motion picture film-based imaging system wherein color chemistries classically needed for optical printing have been removed and wherein image processing necessary to produce various traditional motion picture “film looks” following electro-optical scan and digitization of the film image have been incorporated into an electronic processing step. Further, there is need for such a system to incorporate image processing derived from fundamental characterizations of traditional motion picture film imaging systems rather than by creating comparative relationships between reference images simultaneously captured on two or more imaging media of interest. Further, there is need to define a scan-only type of film with imaging characteristics optimized specifically for generating wide gamut digital data from electro-optical scanning steps wherein the imaging properties of the film allow for maximum usable capture dynamic range, optimized scan noise performance, and imaging characteristics properly described in scanning density response, all in expectation of final look manipulation employing electronic image processing following electro-optical scan steps. Finally, there is need to define bounds for the imaging characteristics of the described scan-only film so as to provide suitable qualities for producing optimized digitized image data via electro-optical scan and further image manipulation.

### SUMMARY OF THE INVENTION

The above needs are addressed according to the present invention by providing a film-based image capture and processing system for producing preferred film-based image looks that includes a scan-only film having reproduction contrast that increases scanning signal-to-noise ratio subject to digitization bit-depth limitations to obtain additional scene exposure differentiation. In addition, a chemical processing subsystem for developing latent images, as a result of image capture, on the scan-only film is included as are a scanner for providing a wide gamut digital image record; and an image processor for modifying film image attributes to digitized images from the scanner.

Another aspect of the present invention provides a method for producing preferred film-based image looks, including providing a scan-only film having reproduction contrast that increases scanning signal-to-noise ratio subject to digitization bit-depth limitations to obtain additional scene exposure differentiation. Subsequently, developing latent images captured on the scan-only film and providing a wide gamut digital image record from a scanner. An image processor modifies digitized images from the scanner with film image attributes.

### ADVANTAGEOUS EFFECT OF THE INVENTION

By trading off the requirement of having an image origination film stock produce an optical image that provides a preferred film look when optically printed or scanned/transferred to video on a telecine, one may employ a single scan-only film optimized to capture additional information (wide gamut) from a scene (relative to conventional image origination film). By having additional scene information available, and scanning the film to produce a digital record of it, the many unique origination film looks can be applied with a processor employing the algorithms that represent select film chemistries to achieve the various image origination film looks. No multiple film origination stocks are needed to achieve the various film looks exhibited by conventional image origination film stocks, since the looks are primarily achieved with the photoscience image processing algorithms rather than the different emulsion chemistries that provide each image origination film stock with its own unique look.

Referring to FIGS. 1-3, another advantage of the present invention (described in FIG. 1) is that when separate image scenes for the same production are also captured (at different places or times) with an electronic camera system as described in U.S. Pat. No. 6,269,217 (referenced in FIG. 2), the images from the two systems can be more easily “intercut” together in sequence since both systems can make use of the same photoscience image processor (PIP) to achieve the same image “origination film look” if desired for consistency throughout the full image content of the production (summarized in FIG. 3).

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is an exemplary workflow diagram according to the present invention.

FIG. 2 is an exemplary workflow diagram illustrating how similar image processing may be applied to images originated via electronic capture to produce traditional motion picture film looks.

FIG. 3 is an exemplary workflow diagram combining elements of a scan-only film origination and electronic capture origination shown progressing through similar image processing, providing evidence of how images from these two types of capture sources may be easily intercut.

FIG. 4 summarizes typical electronic noise behavior in electro-optical scanners.

FIG. 5 is a prior art image processing diagram.

FIG. 6 is a “wide dynamic range” photographic film characteristic curve illustrating an optical density response signature as a function of the logarithm of incident exposure.

FIG. 7 shows index image metadata on the scan-only film.

### DETAILED DESCRIPTION OF THE INVENTION

The present invention consists of two primary components, a type of scan-only film that is optimized primarily for capturing maximum scene information, and an image processing module that applies the look typically associated with a conventional motion picture origination film. The invention is aimed at the television and motion picture markets.

The film would provide a somewhat low-contrast, wide gamut image reproduction that is also maximized for extracting the scene information with optimum signal-to-noise in a film telecine or scanner electro-optical system. Color correction is modified intensively through the removal of masking agents and contamination couplers to achieve the above optimization; although, spectral sensitivity will be carefully controlled to enhance captured color gamut. The present invention allows for achieving a significant increase in linear latitude and a boost in usable dynamic range (exposure latitude) for motion picture applications.

Further, if a scan-only film as described in the present invention is used in conjunction with a system that applied film frame location information metadata onto the film while capturing an image, this information can serve as an index during the electro-optical scanning operation for linking the desired image look to be applied in the secondary image processing steps.

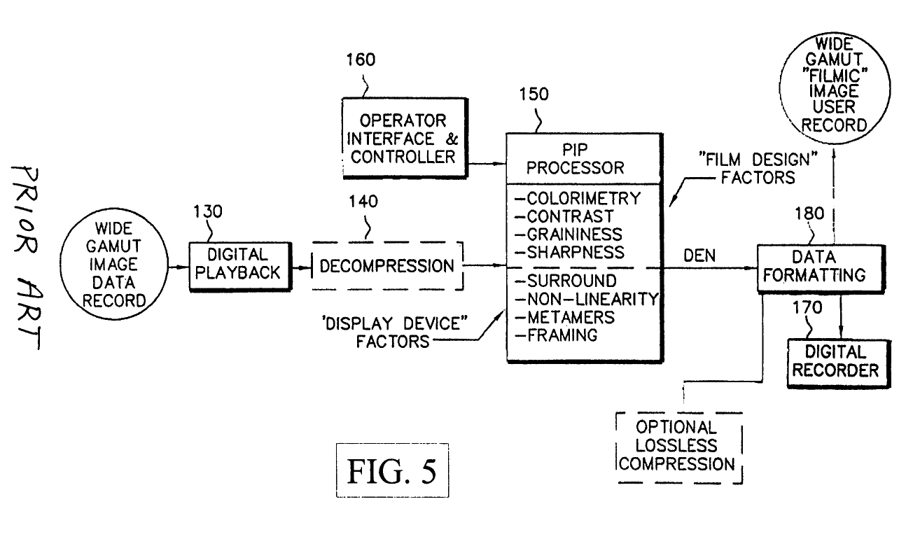

Also by removing the requirement for an origination film stock to possess “film-look-ready” images for either optical printing steps or electro-optical scanning steps, the origination film chemistry is altered and aimed more efficiently at capturing a higher degree of scene information, as well as producing the corresponding developed image with optical attributes that allows for greater information to be extracted, as the result of being better matched to a scanner's electro-optical characteristics. The film needs to be scanned (a type of “scan-only” film) so that the “image processing” chemistry that is removed (and that normally would give an origination film its unique look) can also be applied during a post image processing stage (via software and/or hardware) to achieve multiple origination “film stock” looks. The later applied image processing implements algorithms (in the form of mathematical matrices, 3D look-up tables, or equations) with parameters/values assigned to reproduce the unique film look associated with the particular image processing chemistry formulation that exists in a conventional origination film type. This “scan-only” film enables implementing the same type of image processing algorithms and functional workflow as described in the electronic capture/processing system of U.S. Pat. No. 6,269,217 B1 (after having undergone chemical development and optical scanning)—see FIG. 5. This reference describes not only color, tone, sharpness and texture processing, but also the processing needed to compensate for geometric (framing) and psychophysical viewing phenomena associated with image viewing conditions. Relative to current electronically captured images, origination film emulsion technology (e.g. Kodak ECN films) used in motion picture films can reproduce color image data with wider scene exposure latitude (especially in scene highlights and overexposures) and yield greater red/green/blue spatial resolution. Film provides a longer archival image record (optical) than the current magnetic (e.g. tape) or electro-optic (e.g. optical disk) media used to record/store the image signals from electronic motion cameras.

The present invention will work in concert with an image processing apparatus that is capable of manipulating image signals for both color/tone and image structure (grain/noise and sharpness). Downstream of the processing apparatus, all images are fully available for the standard color correction typically employed in creative post-production for television or theatrical distribution.

In addition to the 2-stage process described above, the present invention can also benefit from the inclusion of any type of pre-visualization video tap system such as described in U.S. Ser. No. 09/712,639 to determine/select which of the image origination film looks available at the second stage to apply to the images being captured during production at the first stage. Moreover, the digital signal processor (DSP) that is part of the video tap system can include the capability to create a metadata record that conveys the image origination film look selection for each captured scene to automate the image processing associated with applying the various selected origination film looks that are added at the second stage. The metadata can also include “circled takes” and camera report data for expediting other post production operations (e.g. creative color correction). Additional on-set features can include a video tap image recorder for subsequent non-linear editing (NLE), as well as wireless connectivity.

The present invention employs algorithms developed from fundamental characterization of the imaging response of subject imaging devices such that reference image data is not required from simultaneous capture on multiple image media and from multiple imaging devices. Further, these fundamental relationships can easily be altered, again without need to re-capture reference scene image data, should emulation of multiple imaging scenarios be desired. These scenarios can include variations in scene color temperature, scene object reflectance spectra, and exposure level among others. Further, film imaging characteristics, as altered by non-standard chemical development techniques, can also be emulated by adjusting image processing algorithms rather than by re-establishing the statistical relationship between images simultaneously captured using two different imaging systems and/or media.

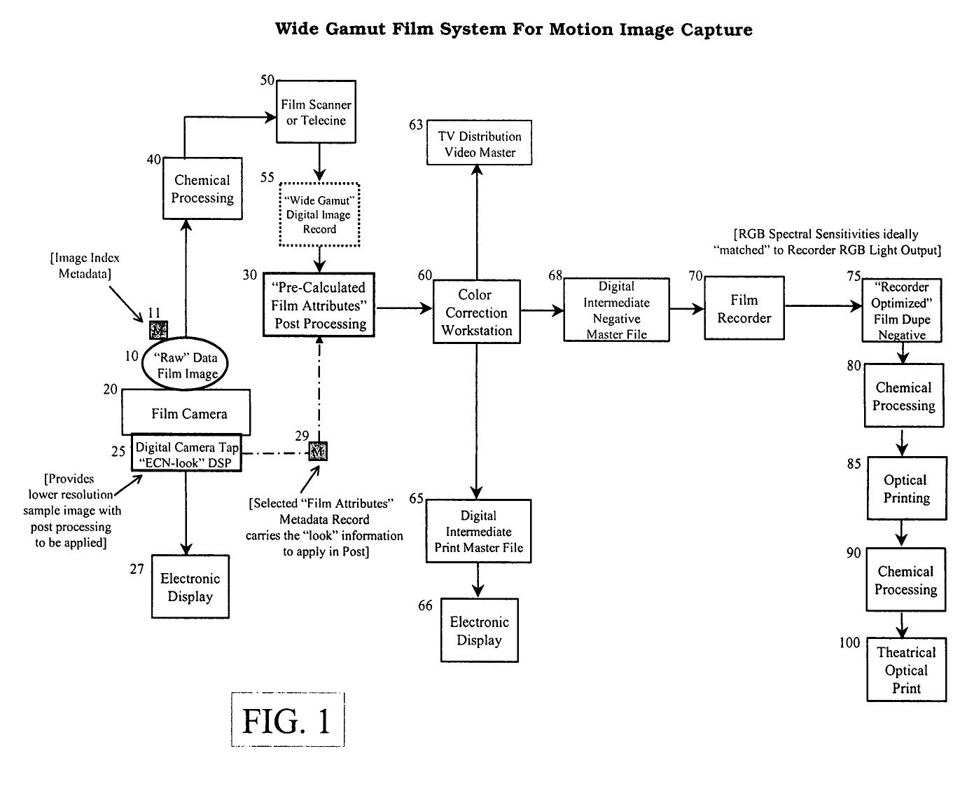

Referring to FIG. 1, the present invention consists primarily of a new type of scan-only film 10 (otherwise referred to as “raw” data film images that will reside in a film camera 20) in combination with a photoscience image processor 30, and it is shown how it could exist in the current image production workflow. The “raw” film 10 inherent characteristics as a sensor of radiation will be such that it is optimized for capturing the maximum amount of information (i.e. wide gamut) from a scene, and its sensitometric/colorimetric properties are such that it provides optimum highest signal-to-noise information (film optical density) to a scanner electro-optical system 50 (e.g., a conventional film telecine or scanner). General film properties specified to capture wide gamut data include a spectral response typical of motion picture origination films, high dynamic range tone reproduction (wide exposure latitude), and a speed comparable to motion picture origination films. To achieve this objective, the film's raw image 10 will not include all the sensitometric/colorimetric image processing chemistry required for producing an optical image record that is ready for optical printing (on motion picture print film) or video transfer. Additionally, image grain/noise will be optimized by utilizing film component inventions outlined in intellectual property associated with Kodak Vision2 500T Color Negative Film, 5218. Though the raw film 10 undergoes conventional chemical processing 40, any traditional “image origination film look” for an acceptable image is supplied at the photoscience image processor 30; hence, providing greater flexibility than conventional film.

Optimization of the image origination film is accomplished by removing color chemistry components such as masking couplers and inhibition couplers which are designed to impart specific preferred color and tone reproduction characteristics in traditional image capture and distribution. With these elements removed, the film system can be designed to maximize light-capture efficiency and minimize image noise or graininess. Color-control components built into traditional image capture films can degrade image quality by reducing the efficiency of light capture and subsequent amplification during chemical processing. By utilizing digitization and manipulation steps subsequent to the capture of the image by the film and the chemical processing of the film, any desired image look can be introduced into the final display and distribution chain.

Most traditional color motion picture films are designed with preferred contrast and colorimetry reproduction for optical printing. In the case of scanning however, further manipulation of the film's characteristic response can be made to enhance image quality during digitization. Specifically, the film's tone transfer function can be lowered in contrast and reduced in gross fog density or minimum density to maximize signal quality for the electro-optical sensor in a typical scanner. Most film scanning technology is based on analog capture by way of photomultiplier tubes or CCD sensors, which when combined with analog-to-digital converters and signal processing electronics yield a video or digital signal proportional to the optical density of the captured and processed optical film image at any particular spatial location as measured by the sensor. Whether the film optical image is described as negative (where the transfer function of the film is such that reproduced optical densities are directly proportional to the level of incident light from the scene) or positive (where the transfer function of the film is such that reproduced optical densities are inversely proportional to the level of incident light from the scene), the optical density representing image content on the film is transferred to the scanner's sensor by way of a source light being focused through the emulsion layers of the film and onto the sensor. The sensor, in turn, measures the signal of incident intensity from the attenuated source light and renders a response level inversely proportional to the measured optical density on the film. As is the case with most photon-counting devices such as scanner sensors, there is a baseline dark current noise at low incident light levels (high film densities) which is generally constant and a photon shot-noise component which is generally proportional to the level of incident light. By designing a film characteristic transfer function with a lowered contrast and lowered minimum density, high reproduction densities which will translate to low incident photon levels on the sensor can be avoided. Further, if the scanned film image is manipulated to a given baselene ‘grading’ for color and contrast, a starting image with lower raw contrast will provide a superior electronic signal-to-noise in the final rendering.

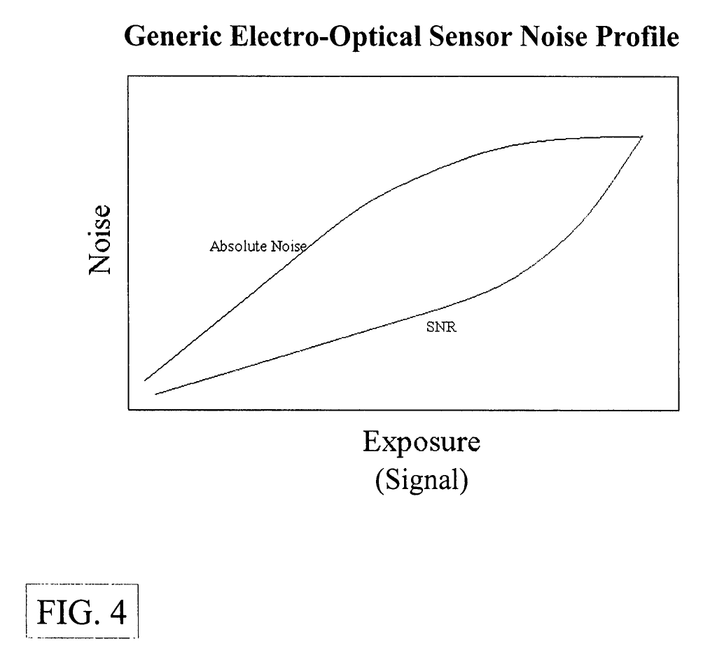

By examination of dark current and photonic shot noise theory, it can be concluded that electronic scanning noise in typical telecines increases as a function of increased exposure on the scanning sensor. The signal-to-noise ratio of the system, however, generally improves with increased exposure (see FIG. 4). By placing as much of the film image then on a higher exposure space for the scanner, electronic noise can be minimized in subsequent image processing.

Despite the simplicity of the preceding argument, the practice of designing films with lower contrasts to yield maximum scanner signal-to-noise performance does have limits. Specifically, as film contrast is lowered, analog-to-digital quantization sampling comes into play relative to acceptable contouring artifact levels. The lower the contrast of the scanned film, the more likely that two consecutive digital sample levels will represent film densities and further, scene exposures that are separated by more than the human visual contrast threshold (as characterized extensively by Barten, “Contrast Sensitivity of the Human Eye and Its Effects on Image Quality,” 1999). As a consequence, a practical lower bound to the contrast of a film can be defined for scanning applications by the following equation (1).
ΔD/ΔE≧(DR/n)/ΔEᵢ (1)

where ΔD is the total range of film reproduction density over a logarithmic exposure range of ΔE

DR is the dynamic range of the scanner in terms of film density

n is the number of quantization levels in the scanner A-to-D

and ΔEᵢ is the human visual threshold for exposure difference (logarithmic again)

In this equation, ΔD/ΔE is the intended film transfer function contrast over a given exposure range. The premise of this equation is that any two consecutive digitized film densities should differ by an equivalent log exposure range less than the human visual threshold. The equation is extensible to any specific luminance level and exposure range over which a defined response is desired. Similar relationships can be drawn for display encoding systems to prevent visual contouring in rendered images.

Optimum film contrast for scanning is thus bounded in one regard by building a characteristic transfer function of minimum contrast to promote the maximum electronic signal-to-noise profile from scanning and in another regard by controlling the contrast reduction to a level which still qualifies under the limits of equation (1), thus preventing contouring artifacts from developing during the digitization process.

In another embodiment, the minimum blue density of the described film may be lowered by removal of traditional color-compensating masking couplers. As color is to be defined by electronic image processing upon electro-optical scanning of the film image, these chemistries, useful for the image reproduction characteristics of traditional films, become unnecessary for the ‘scan-only’ film.

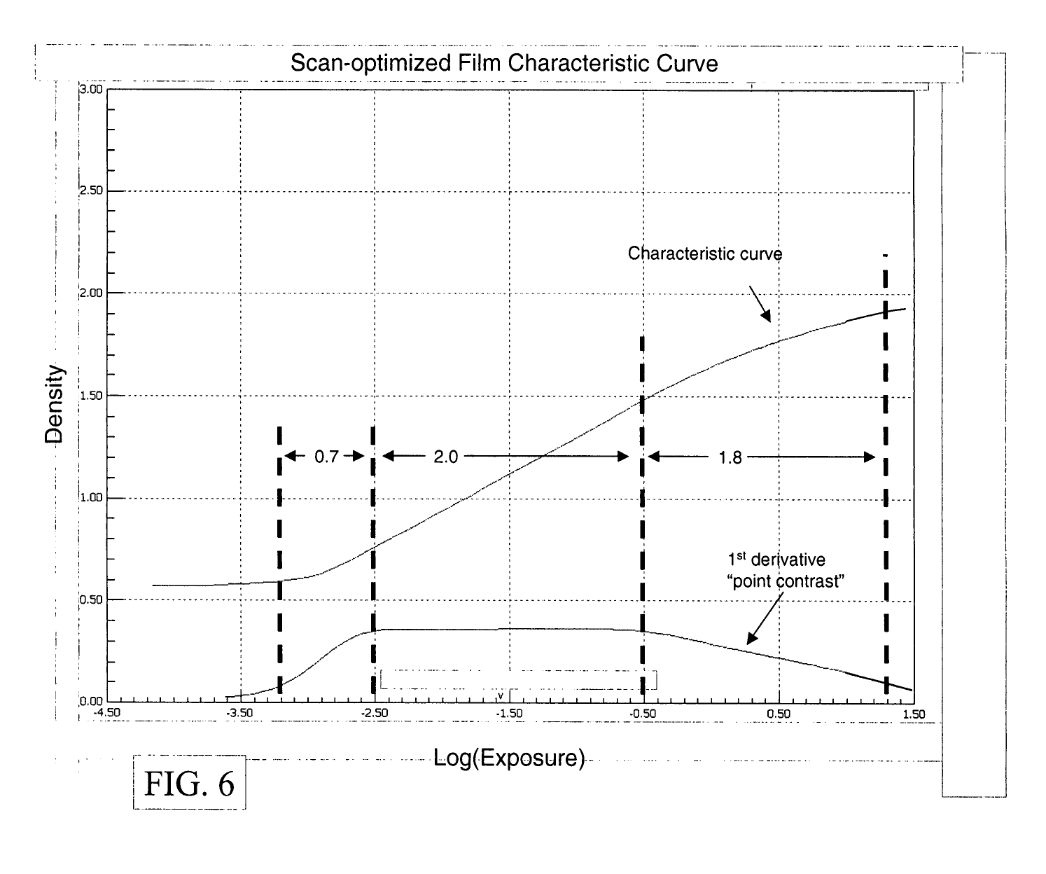

Another aspect of this invention is the creation of a film characteristic transfer function with extended linearity to maximize capture dynamic range. This invention thus comprises a negative color film with red-sensitive, green-sensitive, and blue-sensitive imaging layers which adheres to the following transfer shape definitions: a photographic speed equivalent to current typical motion picture negative films, a non-linear density response versus the logarithm of exposure that is at least 0.7 logE units wide between a point where the contrast is 25% of the mid-scale contrast and the onset of the linear mid-scale contrast, a roughly linear mid-scale contrast that is at least 2.0 logE units wide, and a non-linear contrast roll-off that is at least 1.8 logE units wide between the end of the linear mid-scale contrast region and a point where the contrast has dropped to 25% of the mid-scale level (refer to FIG. 6). The upper-scale specification is especially significant as it addresses the problem of faster contrast roll-off in conventional motion picture films. By defining a higher contrast farther into the upper end of recorded dynamic range, the present invention offers significant improvement in the quality of rendered highlight information upon electro-optical scanning. The preceding definitions are also defined exclusively to scanner density specifications, defined as the integral product of film dye spectrophotometry and electro-optical system spectral response, rather than being generically defined by standard ANSI statusM optical density specifications. This extended linearity, when combined with a lowered contrast provides for enhanced scene dynamic range capture usable in scanning applications.

The scanner electro-optical system 50 yields a “wide gamut” digital image record 55 that has not undergone the sensitometric/colorimetric image processing represented by color chemistry design in a traditional film intended to produce an optical image record that is ready for optical printing (on motion picture print film) or video transfer to a digital wide gamut signal/record. The photoscience image processor 30 is subsequently used to apply the sensitometric/colorimetric image processing that will produce an image with a particular conventional motion picture film origination look for a specific display device. (CRTs, print film, and digital projectors, etc.)—for example, Kodak Vision2 500T Color Negative Film, 5218™. Image attributes controlled by the processor or those associated with achieving a specific image origination film look, including colorimetry, tone reproduction/contrast, graininess, sharpness, illuminant compensation, speed compensation, surround viewing conditions, display non-linearity, metamer equivalency, and image framing—for instance as referenced in U.S. Pat. No. 6,269,217. All image manipulation algorithms are derived by determination of the first characteristic imaging properties (color, tone, etc.) of various traditional motion picture film systems to be emulated. Statistical relationships among all the possible emulation conversions do not need to be created by simultaneously capturing images on multiple motion picture media as any emulation path can be determined from characteristic imaging principles.

Once transformed by the photoscience image processor 30, the digital data now inclusive of image attributes representative of traditional motion picture films and the cinematographer's desired film looks can be further modified in traditional color correction equipment 60. If the color correction equipment 60 is found in a traditional television post-production workflow, the final manipulated image is preserved as a television distribution video master 63. If the color correction equipment 60 is found in a traditional digital intermediate post-production workflow as is used for the digital mastering of images intended for theatrical distribution, the final manipulated image can be prepared as a digital intermediate print master file 65, properly suited for display on an electronic monitor 66, or the final manipulated image can be prepared as a digital intermediate negative master file 68, properly suited for creating a recorder optimized film dupe negative 75 on a film recorder 70. The recorder optimized film dupe negative must undergo prescribed chemical processing 80 to yield a final film negative (not shown). The final theatrical optical print 100 (processed 90 in prescribed chemistry) is produced from subsequent optical printing 85 of the chemically processed recorder optimized film dupe negative 75 as is well understood by those skilled in the art.

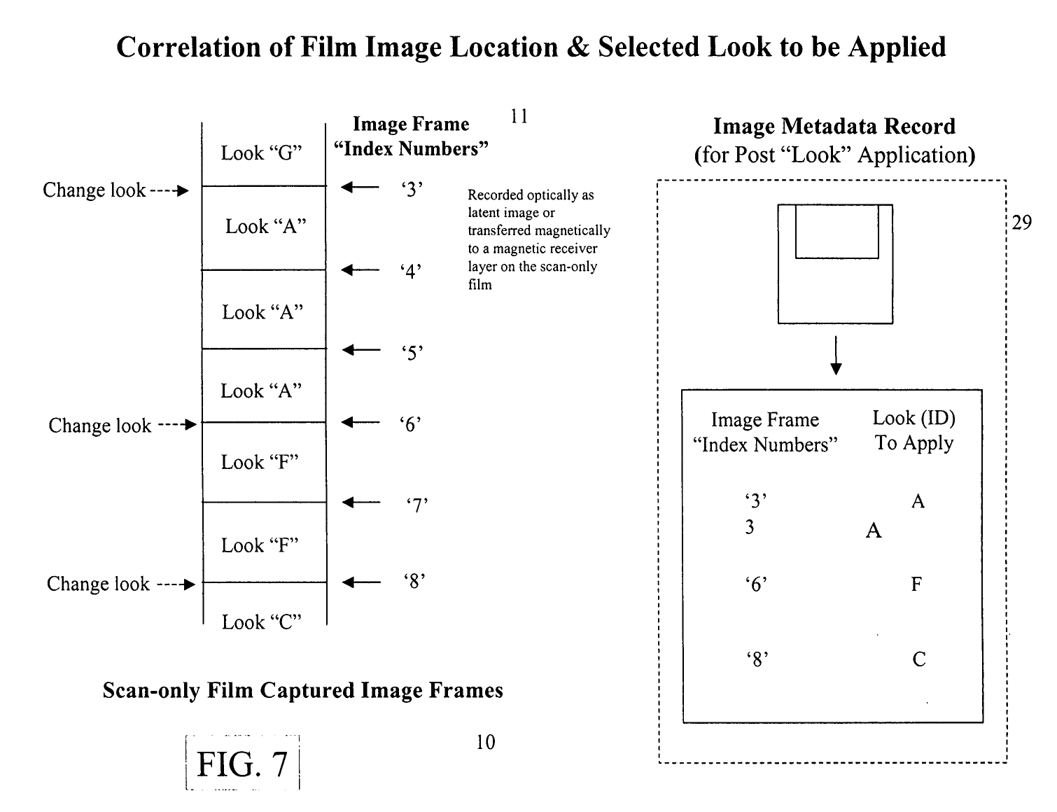

The film camera 20 includes an electronic digital camera tap 25 with a digital signal processor (not shown), and an electronic display 27. The electronic digital tap 25 (incorporated herein by reference according to U.S. Ser. No. 09/712,639) differs from existing systems used with conventional motion picture film cameras in that the electronic digital camera tap 25 exhibits optical spectral sensitivities approximately equal to the “raw” film 10, or spectral responses which are approximately linear combinations of the film's red, green, and blue spectral responses as described in U.S. Ser. No. 09/697,800. The digital camera tap 25 in combination with the digital signal processor (DSP) provides a lower resolution sample image on an electronic display 27 of a selected film image look to be applied in post processing, and if desired, the associated film parameters are recorded as a metadata record/file 29 (e.g. memory card). Metadata record/file 29 contains the selected film look identifiers (IDs) that convey the image origination film look selections that are to be applied to each captured image by photoscience image processor 30. As referenced in FIG. 7, Index Metadata records 11 such as custom “timecode” or “Keykode™” can be further directly exposed onto the scan-only film 10 by way of suitable exposure devices such as LED writers or recorded onto magnetic coatings on the scan-only film via magnetic recording heads within the film camera 20 so as to provide (identify) reference scene location points for applying selected image. “look” attributes in the photoscience image processor 30 via automatic synchronization. By utilizing common image processing for both film originated and electronic originated images in the photoscience image processor, simple intercutting of the two is enabled.

Another embodiment for previsualizing emulations to be applied to the film image described in this invention may come from converting digital still camera images or still film frame images into an intermediate space which can be further manipulated to mimic various traditional motion picture film imaging characteristics as referenced in U.S. Pat. No. 6,122,006, U.S. Patent Publication US2002/0163676A1, and U.S. Ser. No. 10/740,324. The digital still camera could be used in lieu of the electronic digital camera tap 25.

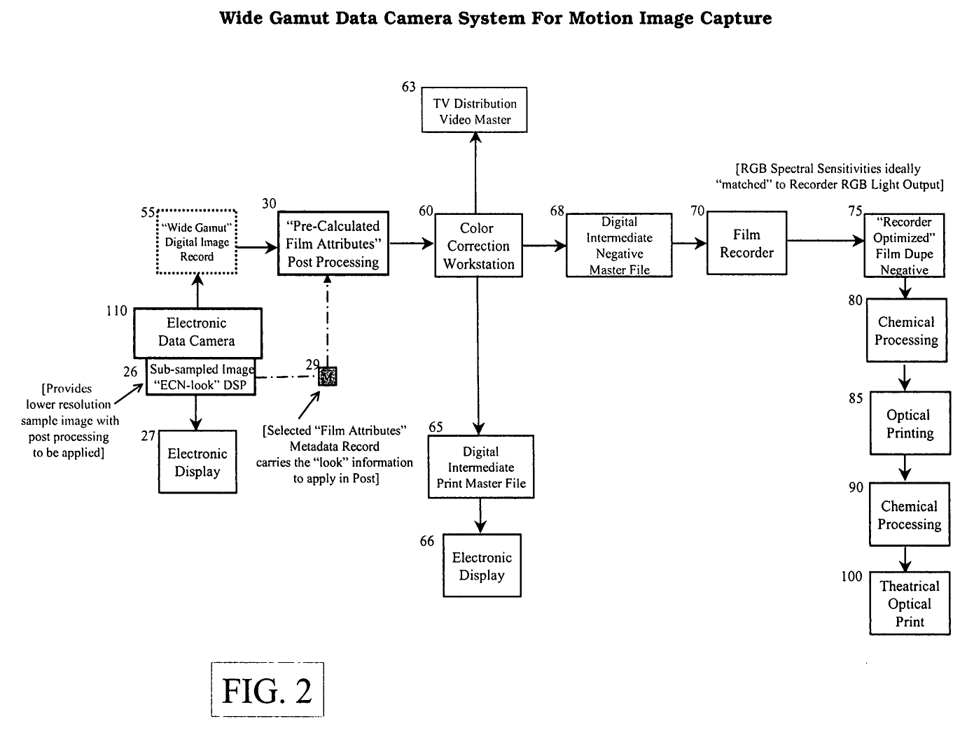

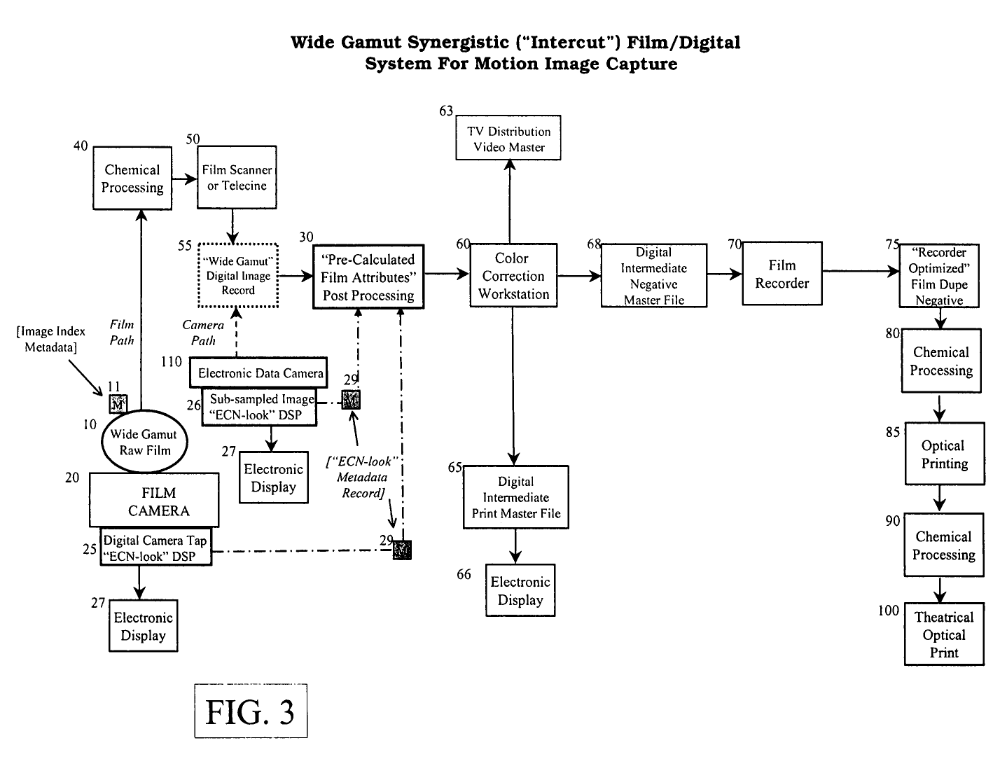

Referring to FIG. 2, wide-gamut digital image records 55 can also be produced from electronic data camera capture 110 as described in U.S. Pat. No. 6,269,217. Different from the example of origination using a film camera 20, the electronic camera may contain sub-sampling DSP 26 to produce preview images suitable for electronic display 27. With the same film-attribute metadata 29 incorporated into this system, synergistic treatment of images captured by way of scan-only film 10 or electronic camera 110 can be achieved with common image processing found in the photoscience image processor 30 (FIG. 3).

In summary, the first stage of the present system is the raw film 10 that will yield, upon scanning, a wide gamut film image digital record 55. A second stage of the present invention employs the functional algorithms of the photoscience image processor 30 which are also utilized by the digital camera tap's DSP 25 in the film camera 20.

The present invention is useful in a conventional motion picture or television content production image chain that typically includes a color corrector workstation (creative effects) 60, creation of a digital intermediate negative master file 68, a film recorder 70, a film dupe negative 75, chemical processing (negative film) additional optical printing and chemical processing (print film) to produce a “theatrical” optical print 100. For image content evaluation (e.g. post-production viewing monitor) or electronic exhibition (e.g. cinema), a color corrector workstation (creative effects) 60 to produce a digital intermediate print master file 65 for electronic display 66. For television production, a color corrector 60 to produce a TV distribution video master 63.

The invention has been described with reference to a preferred embodiment. However, it will be appreciated that variations and modifications can be effected by a person of ordinary skill in the art without departing from the scope of the invention as set forth in the following claims.

### PARTS LIST

“raw” data film image
image index metadata
film camera
digital camera tap
electronic display
metadata record/file
“pre-calculated film attributes” post processing
chemical processing
film scanner or telecine
“wide gamut” digital image record
color correction workstation
TV distribution video master
digital intermediate print master file
electronic display
digital intermediate negative master file
film recorder
“recorder optimized” film dupe negative
chemical processing
optical printing
chemical processing
optical print
electronic camera

1. A film-based image capture and processing system for producing preferred film based image looks comprising,
(a) a scan-only film having reproduction contrast that increases scanning signal-to-noise ratio subject to digitization bit-depth limitations to obtain additional scene exposure differentiation;
(b) a chemical processing subsystem for developing latent images, as a result of image capture, on the scan-only film;
(c) a scanner for providing a wide gamut digital image record; and
(d) an image processor for modifying film image attributes to digitized images from the scanner.

2. The film-based image capture and processing system claimed in claim 1, wherein the film image attributes are selected from the group consisting of color reproduction, tone and contrast reproduction, sharpness, texture (grain), image framing, psychophysical viewing condition adaptation, and display device characteristics and readiness customization.

3. The film-based image capture and processing system claimed in claim 1, further comprising a means for storing digital images.

4. The film-based image capture and processing system claimed in claim 1, further comprising:
(e) a color correction and image enhancement workstation for producing creative or artistic image effects; and
(f) a television distribution video master for display of images.

5. The film-based image capture and processing system claimed in claim 1, further comprising:
(e) a color correction and image enhancement workstation for producing creative or artistic image effects; and
(f) a digital intermediate print master file for display.

6. The film-based image capture and processing system claimed in claim 1, further comprising:
(e) a color correction and image enhancement workstation for producing creative or artistic image effects; and
(f) a digital intermediate negative master file for a film recorder.

7. The film-based image capture and processing system claimed in claim 1, further comprising: an electronic “video tap” camera suitable for producing subsampled images for previewing images with film image attributes.

8. The film-based image capture and processing system claimed in claim 7, wherein the electronic ‘video tap’ camera implements image “look” processing to the subsampled images that results in images that have the same film image attributes that are to be applied to digitized images from the scanner.

9. The film-based image capture and processing system claimed in claim 1, further comprising: a digital camera for still image capture and for providing a preview of final images having the film image attributes.

10. The film-based image capture and processing system claimed in claim 1, further comprising: a collection of image metadata for defining the film image attributes and enabling the image processor to automatically apply the film image attributes to the wide gamut digital image record.

11. The film-based image capture and processing system claimed in claim 1, further comprising: an image index metadata on the scan-only film for providing referenced scene location points for applying film image attributes to the wide gamut digital image record.

12. The film-based image capture and processing system claimed in claim 11, wherein the image index metadata is optically recorded onto the scan-only film during image capture.

13. The film-based image capture and processing system claimed in claim 11, wherein the image index meta is magnetically recorded, during image capture, onto a magnetic receiver that is coated onto the scan-only film.

14. The film-based image capture and processing system claimed in claim 11, wherein the image index metadata is read during electro-optical scanning, and is referenced to image look metadata in order to automatically apply the film image attributes to the wide gamut digital image record.

15. The film-based image capture and processing system claimed in claim 1, wherein the scan-only film further includes:
(a) at least 3 color sensitive records for recording red light, green light, and blue light content from a photographed scene;
(b) photographic film speed that is equivalent to motion picture color photographic films;
(c) removal of color chemistries that are useful for preparing an image suitable for optical printing;
(d) removal of color masking couplers to lower gross optical fog density;
(e) exposure latitude, including a non-linear density response versus the logarithm of exposure that is at least 0.7 logE units wide between a point where the contrast is 25% of the mid-scale contrast and the onset of the linear mid-scale contrast, a roughly linear mid-scale contrast that is at least 2.0 logE units wide, and a non-linear contrast roll-off that is at least 1.8 logE units wide between the end of the linear mid-scale contrast region and a point where the contrast has dropped to 25% of the mid-scale level.

16. A method for producing preferred film-based image looks, comprising the steps of:
(a) providing a scan-only film having reproduction contrast that increases scanning signal-to-noise ratio subject to digitization bit-depth limitations to obtain additional scene exposure differentiation;
(b) developing latent images captured on the scan-only film;
(c) providing a wide gamut digital image record from a scanner; and
(d) employing an image processor for modifying digitized images from the scanner with film image attributes.

17. The method claimed in claim 16, wherein the film image attributes are selected from the group consisting of color reproduction, tone and contrast reproduction, sharpness, texture (grain), image framing, psychophysical viewing condition adaptation, display device characteristics, and readiness customization.

18. The method claimed in claim 16, further comprising the step of storing the digitized images.

19. The method claimed in claim 16, further comprising the steps of:
(a) producing creative or artistic image effects with a color correction and image enhancement workstation; and
(b) displaying, in a television format, a television distribution video master.

20. The method claimed in claim 16, further comprising the steps of:
(e) producing creative or artistic image effects with a color correction and image enhancement workstation; and
(f) displaying images from a digital intermediate print master file.

21. The method claimed in claim 16, further comprising the steps of:
(e) producing creative or artistic image effects with a color correction and image enhancement workstation; and
(f) employing a digital intermediate negative master file for a film recorder.

22. The method claimed in claim 16, further comprising the step of: producing subsampled images for previewing images with film image attributes.

23. The method claimed in claim 22, wherein the subsampled images undergo image “look” processing that results in images that have the same film image attributes that are to be applied to digitized images from the scanner.

24. The method claimed in claim 16, further comprising the steps of:
(e) defining the film image attributes from a collection of image metadata; and
(f) automatically applying the film image attributes to the wide gamut digital image record.

25. The method claimed in claim 16, further comprising the step of: employing image index metadata found on the scan-only film to provide referenced scene location points for applying film image attributes to the wide gamut digital image record.

26. The method claimed in claim 25, wherein the image index metadata is optically recorded onto the scan-only film during image capture.

27. The method claimed in claim 25, wherein the image index metadata is magnetically recorded onto the scan-only film during image capture.

28. The method claimed in claim 25, wherein the image index metadata is read during electro-optical scanning, and is referenced to image look metadata in order to automatically apply the film image attributes to the wide gamut digital image record.

29. The method claimed in claim 16, further comprising the step of providing a preview of final images having the film image attributes from images captured with a digital still camera.

30. The method claimed in claim 16, wherein image processing is tailored to produce content master data suitable for a variety of post-production formats and venues.

31. The method claimed in claim 30, wherein the content master data is suitable for further color correction in corresponding color grading equipment.

32. The method claimed in claim 30, wherein the content master data is suitable for video broadcasting via television standards or formats.

33. The method claimed in claim 30, wherein the content master data is suitable for mastering in a traditional digital intermediate post-production workflow subject to a final manipulated image prepared as a digital intermediate print master file and subsequent display on an electronic monitor.

34. The method claimed in claim 30, wherein the content master data is suitable for mastering in a traditional digital intermediate post-production workflow subject to a final manipulated image prepared as a digital intermediate negative master file that enables creating a film dupe negative from a specified film recorder.

35. A method for applying common image film attributes to a captured image from an electronic camera and a scan-only film wherein both the electronic camera and the scan-only film have image capture spectral equivalency characteristics, and the scan-only film has color chemistries removed that are normally useful for preparing a film image suitable for optical printing, and the electronic camera lacks standard video encoding required to be compatible for television display and distribution, the method comprising the steps of:
i. capturing an electronic image with the electronic camera to produce digital image data;
ii. capturing a film image using the scan-only film;
iii. processing the scan-only film;
iv. electro-optically scanning the scan-only film to produce digital image data, and;
v. intercutting the digital image data of the electronic camera with the digital image data derived from the scan-only film to produce a combined digital image set for subsequent image processing.
